(19) United States
(12) Patent Application Publication
(10) Pub. No.: US 2005/0074141 A1
(43) Pub. Date: Apr. 7, 2005

(54) Image processing apparatus and method and program

(75) Inventor: Nobuhiro Tsunashima, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/915,360

(22) Filed: Aug. 11, 2004

(30) Foreign Application Priority Data
Aug. 22, 2003 (JP) 2003-298066

(51) Int. Cl. G06K 9/00; G06K 9/68; H04N 7/18

(52) U.S. Cl. 382/103; 382/218; 348/152; 382/168

(57) ABSTRACT

An image processing apparatus and method is disclosed by which a body can be detected using two picked-up images. An image storage section stores a current image supplied from an image pickup apparatus. A reference image storage section has stored therein a preceding image at a preceding timing. A difference calculation section produces a difference image between the current image supplied from the image storage section and the preceding image supplied from the reference image storage section. A labeling section performs labeling for the difference image to produce a difference region. A determination section determines, from regions of the current and preceding images corresponding to the difference region and surrounding regions of the current and preceding images around the regions corresponding to the difference region, whether the difference region is a region in which a body appears or a region in which a body disappears. The image processing apparatus can be applied to detection of a body from within an image.

### BACKGROUND OF THE INVENTION

This invention relates to an image processing apparatus and method and a program, and more particularly to an image processing apparatus and method and a program wherein, for example, two picked-up images can be used to detect a body.

An image process wherein a picked-up image picked up by an image pickup apparatus such as an ITV (Industrial Television) camera or the like is processed is applied to security systems, marketing systems and so forth. For example, in an image process of a monitoring system in which an image pickup apparatus such as an ITV camera is used, a process (image process) of detecting (extracting), from within a picked-up image picked up by the image pickup apparatus, a body such as, for example, a person or a car who or which is in the picked-up image is performed.

For example, in order to monitor so that an unspecified person may not enter an off-limits place, an IV camera is installed at a place at which it can pick up an image of the off-limits place. Then, an image process of detecting, from within a picked-up image picked up by the ITV camera, whether or not a body newly appearing in (entering) the picked-up image is present. If such a body is detected, then a signal for generating an alarm is outputted.

Further, if a body in a picked-up image can be detected, then also the moving direction of the body can be recognized. As an example of utilization of such an image process of detecting the moving direction of a body as just described, the following marketing or the like is available. In particular, an ITV camera or the like is installed at a place where a great number of people visit such as a department store or a railway station to detect or trace a traveling person. Then, data of the moving directions of such traveling persons are utilized to investigate flows of persons.

In the image process described above, it is significant how to detect a body which has newly appeared or moved in the picked-up image (body detection process).

The body detection process includes, as basic processes, for example, processes depending upon a time difference and a background difference. The process depending upon a time difference is a process (difference detection process) in which picked-up images before and after a unit period of time (for example, a period of one frame) are used to detect a region (hereinafter referred to as difference region) in which the luminance (brightness) exhibits a difference in a picked-up image which is used as a reference. On the other hand, in the process depending upon a background difference, utilizing the fact that an image pickup apparatus is usually fixed at a predetermined position to pick up an image, an image in a normal or regular state is picked up in advance and stored as a template into a predetermined storage apparatus. Then, the background difference process compares a picked-up image with the image stored as a template in the predetermined storage apparatus (such image is hereinafter referred to as template image) to detect a region which exhibits a variation of the luminance (brightness) in the picked-up image of the reference. Here, where the place at which image pickup is performed is outdoors, it is often the case that a plurality of template images picked up in different brightness conditions of the surroundings such as images in the morning and daytime and at night are stored and a template image to be used for comparison is selected depending upon the brightness or the time of the picked-up image.

For example, in the body detection process depending upon a time difference, if a body moves in a picked-up image, then the luminance of a region of the picked-up image after the movement (such region is hereinafter referred to as body region) varies from that of the region at the same position of the picked-up image before a unit time period which is before the movement of the body as that of the body region after the movement. Therefore, the difference (interframe difference) in luminance between the picked-up image picked up at the present point of time and the picked-up image picked up prior by a unit time period is calculated, and a region which exhibits a difference in brightness is determined as a region in which a body exists.

However, where a difference in luminance is found between picked-up images before and after a unit period of time, two cases are available including a case wherein a body appears and another case wherein a body disappears. In particular, if no body exists in a picked-up image picked up at certain time i but a body moves to or newly appears in a predetermined region of another picked-up image picked up after a unit period of time (at time i+1), then a difference appears between the picked-up image at time i and the picked-up image after a unit period of time (at time t+1). On the contrary, if a body exists in a predetermined region of a picked-up image picked up at certain time i but the body moves and disappears from the region of another picked-up image picked up after a unit period of time (at time i+1), then a difference appears between the picked-up image at time i and the picked-up image after a unit period of time (at time t+1). Accordingly, in order to determine that a body exists in a region which exhibits a difference in luminance, it is necessary to determine whether a difference region of a picked-up image originates from appearance of a body or disappearance of a body.

In order to determine such appearance or disappearance of a body as just described, a processing method of detecting a moving body making use of three picked-up images picked up in a time series is disclosed, for example, in Japanese Patent Laid-Open No. 2000-82145 (hereinafter referred to as Patent Document 1).

The method proposed in Patent Document 1 is described briefly.

It is to be noted that, since a body can be detected by a similar process in both cases wherein a body appears in a picked-up image and wherein a body moves in a picked-up image, the following description is given assuming that a body moving in a picked-up image is detected.

FIG. 1 illustrates a related-art body detection process proposed in Patent Document 1.

Referring to FIG. 1, a frame image (hereinafter referred to simply as image) f(i−1) is an image picked up by an image pickup apparatus at time i−1. Meanwhile, another image f(i) is an image picked up by the image pickup apparatus at time i. Similarly, a further image f(i+1) is an image picked up by the image pickup apparatus at time i+1. Here, it is assumed that the time intervals between the time i−1 and the time i and between the time i and the time i+1 are equal to a frame interval (1/30 second). Further, it is assumed that the image pickup apparatus is fixed and normally picks up an image of the same position (place).

In the image f(i−1), a round body V is picked up at a right upper portion of the image f(i−1) and is displayed as a round region Vs(i−1) having a lower luminance value (being darker) than a background region BK. Accordingly, the region Vs(i−1) is a body region Vs(i−1) in the image f(i−1). Here, it is assumed that the image pickup apparatus is a monochromatic ITV camera and outputs a luminance value of, for example, 8 bits as a pixel value of each pixel.

An image of the body V is picked up at a central portion of the image f(i) and is displayed as a body region Vs(i) of a luminance value lower than that of the background region BK at the position. Further, the body V is picked up at a left lower portion of the image f(i+1), and is displayed as a body region Vs(i+1) of a luminance value lower than that of the background region BK at the position.

Accordingly, between the time i−1 and the time i+1, the body V moves in the leftwardly downward direction from the right upper portion of the region being picked up.

It is assumed that, in FIG. 1, the body V which moves in the image f(i) at time i is to be detected.

First, with regard to the image f(i−1) and the image f(i), a difference image fd(i,i−1) formed from differences (interframe differences) between luminance values of mutually corresponding pixels is produced. Similarly, with regard to the image f(i) and the image f(i+1), a difference image fd(i,i+1) formed from differences (interframe differences) between luminance values of mutually corresponding pixels is produced.

The difference image fd(i,i−1) includes two difference regions produced by appearance and disappearance of the body V. In particular, if attention is paid to the image f(i), a difference region s(i,1) originating from appearance of the body V and another difference region s(i,2) originating from disappearance of the body V exist in the image f(i).

Also in the difference image fd(i,i+1), two difference regions originating from appearance and disappearance of the body V exist. In particular, if attention is paid to the image f(i), a difference region s(i+1,2) originating from appearance of the body V and another difference region s(i+1,1) originating from disappearance of the body V exist in the image f(i).

Accordingly, if the body V appears in the image f(i), then a difference region originating from appearance of the body V is included in both of the two difference images fd(i,i−1) and fd(i,i+1).

Thus, an intersection between the two difference images fd(i,i−1) and fd(i,i+1) is calculated. As a result, only the body region Vs(i) of the image f(i) is determined as seen at the lowest stage in FIG. 1.

However, in the body detection process proposed in Patent Document 1 described above, three picked-up images are required to detect a body. In an image process in a security system or the like, it is usually necessary to perform processing on the real time basis and continuously for a long period of time. In this instance, the process which uses three picked-up images has problems that a large capacity is required for the memory for storing images and that a long period of time is required for image processing.

### SUMMARY OF THE INVENTION

It is an object of the present invention to provide an image processing apparatus and method and a program by which a body can be detected using two picked-up images.

In order to attain the object described above, according to an aspect of the present invention, there is provided an image processing apparatus including difference region detection means for detecting a difference region in which a first image and a second image supplied from image pickup means for picking up an image have a difference, and determination means for determining the similarity between an image of the difference region and an image in a peripheral region around the difference region and determining based on the similarity whether the difference region is a region in which a body appears or a region in which a body disappears.

According to another aspect of the present invention, there is provided an image processing method including a difference region detection step of detecting a difference region in which a first image and a second image supplied from image pickup means for picking up an image have a difference, and a determination step of determining the similarity between an image of the difference region and an image in a peripheral region around the difference region and determining based on the similarity whether the difference region is a region in which a body appears or a region in which a body disappears.

According to a further aspect of the present invention, there is provided a program for causing a computer to execute a process including a difference region detection step of detecting a difference region in which a first image and a second image supplied from image pickup means for picking up an image have a difference, and a determination step of determining the similarity between an image of the difference region and an image in a peripheral region around the difference region and determining based on the similarity whether the difference region is a region in which a body appears or a region in which a body disappears.

In the image processing apparatus and method and the program, a difference region in which a first image and a second image supplied from the image pickup means for picking up an image have a difference is detected. Then, the similarity between an image in the difference region and an image in a peripheral region around the difference region is determined, and based on the similarity, it is determined whether the difference region is a region in which a body appears or a region in which a body disappears.

The image processing apparatus may be an independent apparatus or may alternatively be a block which performs image processing in one apparatus.

With the image processing apparatus and method and the program, a body can be detected using two picked-up images.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a diagrammatic view illustrating a related-art body detection process;

FIG. 2 and FIGS. 3A to 3D are diagrammatic views and graphs, respectively, illustrating an outline of a body detection process to which the present invention is applied;

FIG. 4 is a block diagram showing an example of a configuration of an image processing apparatus which performs the body detection process to which the present invention is applied;

FIG. 5 is a flow chart illustrating the body detection process of the image processing apparatus of FIG. 4;

FIG. 6 is a block diagram showing another example of a configuration of an image processing apparatus which performs the body detection process to which the present invention is applied;

FIG. 7 is a flow chart illustrating the body detection process of the image processing apparatus of FIG. 6; and

FIG. 8 is a block diagram showing an example of a configuration of a computer to which the present invention is applied.

### DETAILED DESCRIPTION OF THE PREFERRED EMBODIMENTS

Before preferred embodiments of the present invention are described in detail, a corresponding relationship between several features set forth in the accompanying claims and particular elements of the preferred embodiments described below is described. The description, however, is merely for the confirmation that the particular elements which support the invention as set forth in the claims are disclosed in the description of the embodiments of the present invention. Accordingly, even if some particular element which is set forth in description of one of the embodiments is not set forth as one of the features in the following description, this does not signify that the particular element does not correspond to the feature. On the contrary, even if some particular element is set forth as an element corresponding to one of the features, this does not signify that the element does not correspond to any other feature than the element.

Further, the following description does not signify that the prevent invention corresponding to particular elements described in the embodiments of the present invention is all set forth in the claims. In other words, the following description does not deny the presence of an invention which corresponds to a particular element described in the description of the embodiments of the present invention but is not set forth in the claims, that is, the description does not deny the presence of an invention which may be filed for patent in a divisional patent application or may be additionally included into the present patent application as a result of later amendment to the claims.

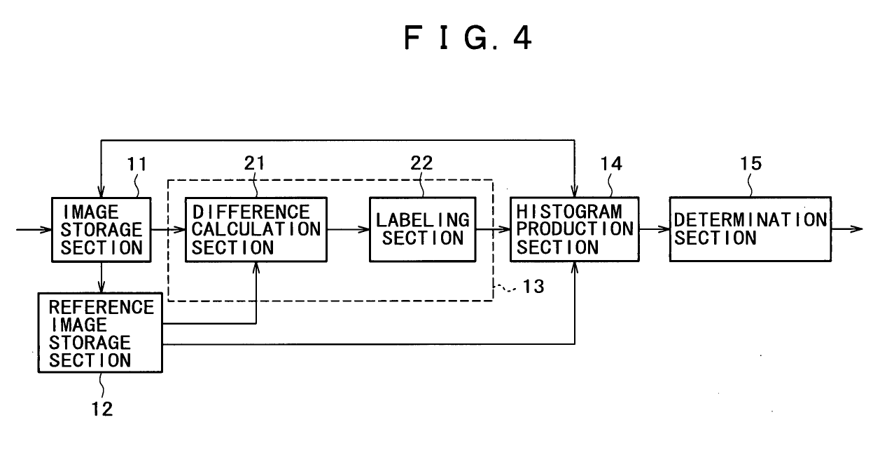

An information processing apparatus as set forth in claim 1 includes difference region detection means (for example, a difference region detection section 13 of FIG. 4) for detecting a difference region in which a first image and a second image supplied from image pickup means for picking up an image have a difference, and determination means (for example, a determination section 15 of FIG. 4) for determining the similarity between an image of the difference region and an image in a peripheral region around the difference region and determining based on the similarity whether the difference region is a region in which a body appears or a region in which a body disappears.

An image processing apparatus as set forth in claim 2 is configured such that the difference region detection means includes comparison means (for example, a difference calculation section 21 of FIG. 4) for comparing pixel values of corresponding pixels of the first and second images with each other, and detects the difference region based on a result of the comparison by the comparison means.

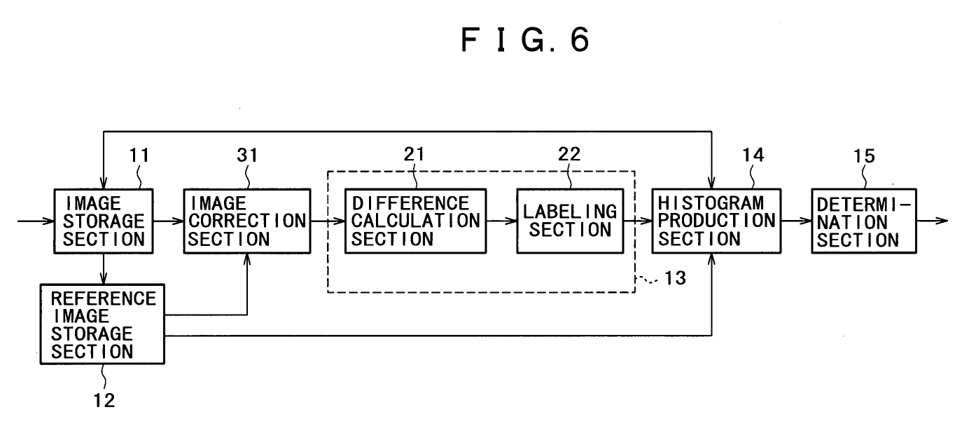

An image processing apparatus as set forth in claim 9 further includes correction means (for example, an image correction section 31 of FIG. 6) for performing a predetermined correction process for the first and second images, and wherein the difference region detection means detects a difference region in which the first and second images after the predetermined correction process have a difference.

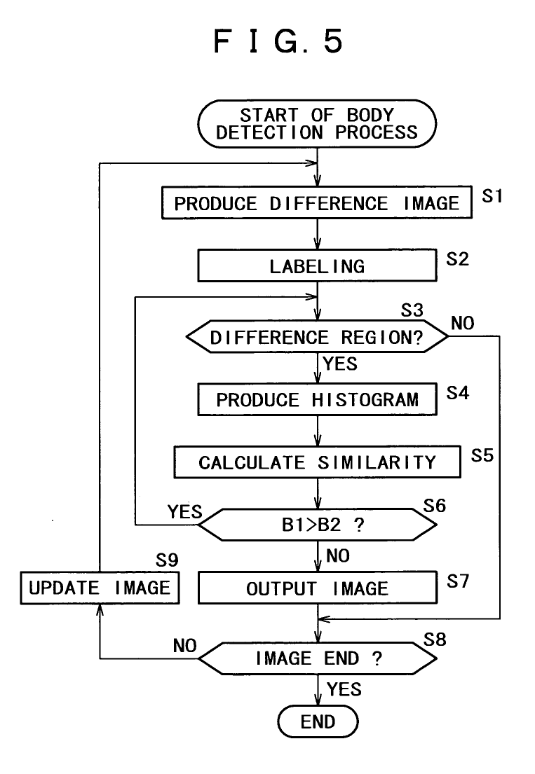

An image processing method as set forth in claim 10 includes a difference region detection step (for example, steps S1 and S2 of FIG. 5) of detecting a difference region in which a first image and a second image supplied from image pickup means for picking up an image have a difference, and a determination step (for example, a step S6 of FIG. 5) of determining the similarity between an image of the difference region and an image in a peripheral region around the difference region and determining based on the similarity whether the difference region is a region in which a body appears or a region in which a body disappears.

Also particular examples at individual steps of a program as set forth in claim 11 are similar to those in the embodiment of the present invention at the steps of the image processing method as set forth in claim 10.

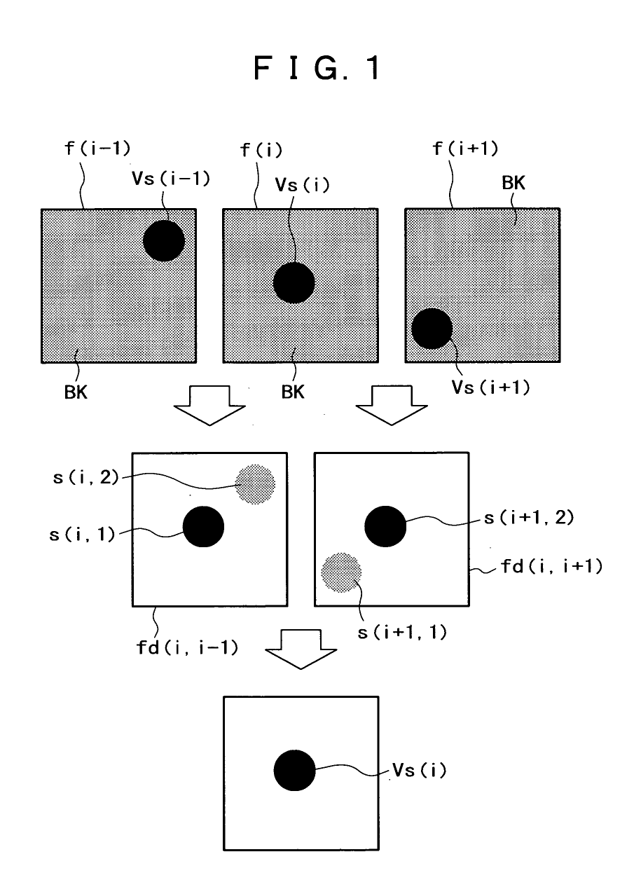

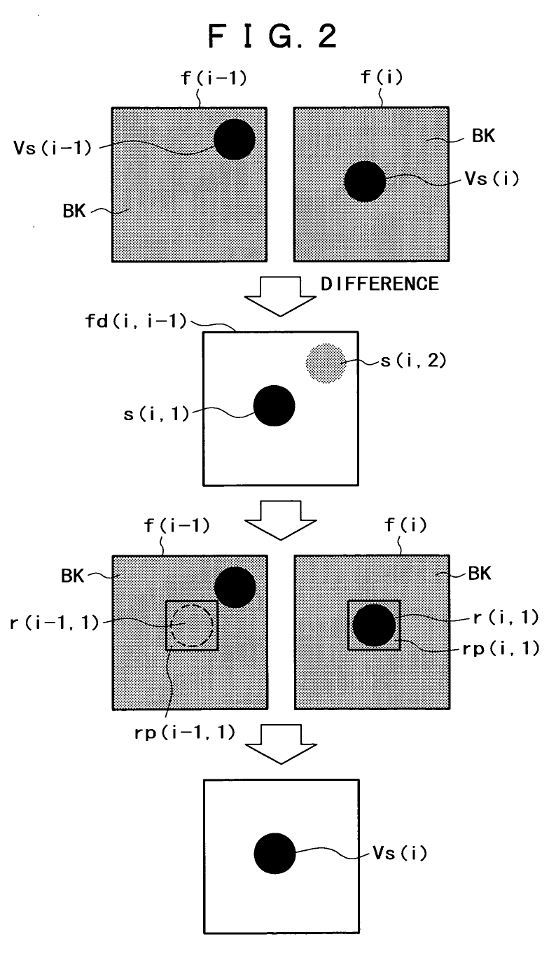

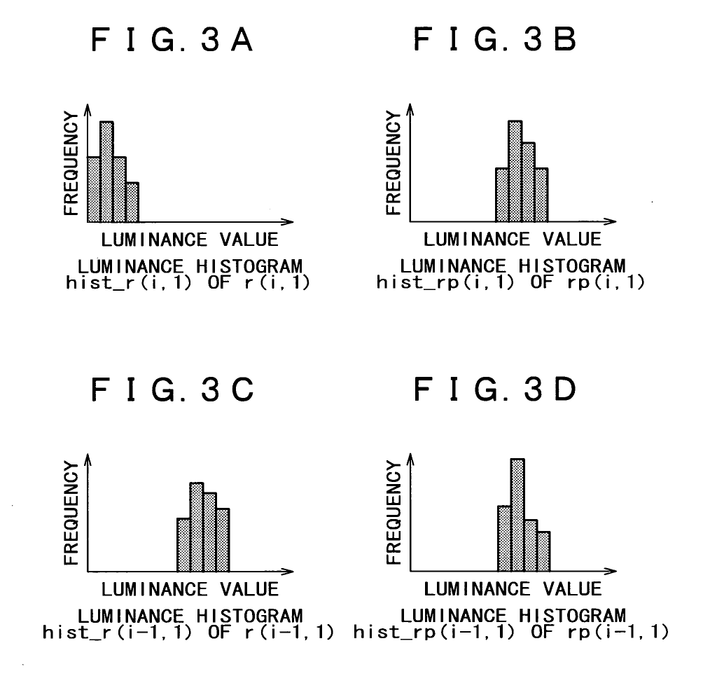

First, an outline of the body detection process of the present invention is described with reference to FIGS. 2 and 3A to 3D. It should be noted that, in FIG. 2, parts corresponding to those in FIG. 1 are referred to the same symbols and the descriptions thereof are arbitrarily omitted.

FIG. 2 illustrates a body moving in an image f(i) similarly as in the case described hereinabove with reference to FIG. 1 but using two images f(i) and f(i−1). Here, between time i and time i+1, the body V moves from a right upper portion to a central portion of a region (space) being picked up.

First, a difference image fd(i,i−1) is produced from differences (interframe differences) between luminance values of corresponding pixels of the image f(i−1) and the image f(i) similarly as in the case described hereinabove with reference to FIG. 1.

Here, in the difference image fd(i,i−1), two difference regions produced by appearance and disappearance of a single body V exist similarly as in the case of FIG. 1. In particular, in the image f(i), a difference region s(i,1) originating from appearance of the body V and another difference region s(i,2) originating from disappearance of the body V exist.

Since the difference region s(i,1) is a region originating from appearance of the body V in the image f(i), the final object of the body detection process is to detect or extract the difference region s(i,1) as a body region Vs(i) and erase the difference region s(i,2) which is not a body region Vs(i).

To this end, the following process is performed with regard to the difference regions s(i,1) and s(i,2). It is to be noted that the following description is given of a case wherein the process is performed for the difference region s(i,1).

A region corresponding to the position of the difference region s(i,1) in the difference image fd(i,i−1) is set to each of the images f(i−1) and f(i), and the regions thus set are represented as image regions r(i−1,1) and r(i,1), respectively.

Further, a peripheral region rp(i−1,1) is set with respect to the image region r(i−1,1). Here, the peripheral region rp(i−1,1) is defined, for example, as a region surrounded by a contour of a region formed by expanding a rectangular region circumscribing the image region r(i−1,1) by C1 pixels set in advance in upward, downward, leftward and rightward directions and a contour of the image region r(i−1,1). A peripheral region rp(i,1) is set also with respect to the image region r(i,1) similarly.

Here, it is assumed that the difference region s(i,1) in the image f(i) originates from appearance of the body V. In this instance, the image region r(i−1,1) of the image f(i−1) is part of the background region BK (such part is hereinafter referred to simply as background region BK), and the image region r(i,1) of the image f(i) makes a body region Vs(i).

Meanwhile, the peripheral region rp(i−1,1) of the image f(i−1) and the peripheral region rp(i,1) of the image f(i) both make the background region BK.

Accordingly, since the image region r(i−1,1) and the peripheral region rp(i−1,1) therearound both make the background region BK, the similarity in image region between the image region r(i−1,1) and the peripheral region rp(i−1,1) is high. In other words, the image region r(i−1,1) and the peripheral region rp(i−1,1) make similar images.

On the other hand, the similarity in image region between the image region r(i,1) and the peripheral region rp(i,1) therearound is low because the image region r(i,1) makes the body region Vs(i) and the peripheral region rp(i,1) makes the background region BK.

Therefore, when the assumption is true, that is, when the difference region s(i,1) of the image f(i) originates from appearance of the body V, the similarity in image region between the image region r(i−1,1) and the peripheral region rp(i−1,1) must be higher than the similarity in image region between the image region r(i,1) and the peripheral region rp(i,1).

On the contrary, if the similarity in image region between the image region r(i−1,1) and the peripheral region rp(i−1,1) is lower than the similarity in image region between the image region r(i,1) and the peripheral region rp(i,1), then the assumption is false, that is, the difference region s(i,1) of the image f(i) originates from disappearance of the body V.

Therefore, the similarities in image region between the image region r(i−1,1) and the peripheral region rp(i−1,1) and between the image region r(i,1) and the peripheral region rp(i,1) are calculated, and the relationship in magnitude of the similarities is determined by comparison between them to determine whether or not the difference region s(i,1) of the image f(i) originates from appearance of the body V.

Now, a determination method (calculation method) of the similarity in image region is described.

Several methods are available for determining the similarity in image region. For example, a method which uses a luminance histogram of an image region and a method which uses a texture analysis are available. Here, it is determined that the method wherein a luminance histogram is used is adopted, and the method is described below. It is to be noted that the method wherein a texture analysis is used is described, for example, in Osamu HASEGAWA et al, “Proposal of scene recognition by learning and basic experiments therefor”, Third Symposium on Sensing via Image Information, pp. 129-132 (June, 1997).

Several methods are available also for a method wherein a luminance histogram of an image region is used to make a determination of the similarity. For example, a method of determining a sum of absolute difference, another method of determining a square error and a further method which uses inner products, of factors of a histogram are available. Here, a method of determining the similarity between image regions using the method which uses inner products of factors of a histogram is described.

First, a luminance histogram is produced for four regions of the image region r(i−1,1), peripheral region rp(i−1,1), image region r(i,1) and peripheral region rp(i,1) of FIG. 2.

FIGS. 3A to 3D show the luminance histograms of the four regions of the image region r(i,1), peripheral region rp(i,1), image region r(i−1,1) and peripheral region rp(i−1,1).

Referring to FIG. 3A, the histogram indicates the luminance histogram hist_r(i,1) of the image region r(i,1). Referring to FIG. 3B, the histogram indicates the luminance histogram hist_rp(i,1) of the peripheral region rp(i,1). Referring to FIG. 3C, the histogram indicates the luminance histogram hist_r(i−1,1) of the image region r(i−1,1). Referring to FIG. 3D, the histogram indicates the luminance histogram hist_rp(i−1,1) of the peripheral region rp(i−1,1). Here, the axis of abscissa of the luminance histograms represents the luminance value (pixel value) of each pixel represented by 8 bits (0 to 255), and the axis of ordinate represents the frequency (number of times) of pixels of each luminance.

In the image f(i) of FIG. 2, since the image region r(i,1) is a body region Vs(i), the luminance histogram hist_r(i,1) exhibits a high frequency of those pixels which are dark (low in luminance value) as seen from FIG. 3A.

Meanwhile, the other three luminance histograms hist_rp(i,1), hist_r(i−1,1) and hist_rp(i−1,1) have a higher frequency of those pixels which are brighter (higher in luminance value) than those of the luminance histogram hist_r(i,1) because the peripheral region rp(i,1), image region r(i−1,1) and peripheral region rp(i−1,1) are the background region BK. Further, the three luminance histograms hist_rp(i,1), hist_r(i−1,1) and hist_rp(i−1,1) exhibit a high frequency of similar luminance values.

Since the method which uses inner products of factors of a histogram is adopted as a method of determining the similarity between image regions, the inner product value B1 of the luminance histogram hist_r(i,1) and the luminance histogram hist_rp(i,1) and the inner product value B2 of the luminance histogram hist_r(i−1,1) and the luminance histogram hist_rp(i−1,1) are calculated. The inner product values B1 and B2 can be represented as given by the following expressions (1) and (2), respectively:

$$\begin{matrix}B1 = hist\_r ( i , 1 ) \cdot hist\_rp ( i , 1 ) \\ = \sum hist\_r ( i , 1 ) ( P ( j ) ) \times \\ hist\_rp ( i , 1 ) ( P ( j ) )\end{matrix} \qquad ( 1 )$$

where hist_r(i,1)(P(j)) represents the frequency (number of times) of the luminance value j on the luminance histogram hist_r(i,1), hist_rp(i,1)(P(j)) the frequency (number of times) of the luminance value j on the luminance histogram hist_rp(i,1), and Σ the summation of the luminance value j=0 to 255.

$$\begin{matrix}B2 = hist\_r ( i - 1 , 1 ) \cdot hist\_rp ( i - 1 , 1 ) \\ = \sum hist\_r ( i - 1 , 1 ) ( P ( j ) ) \times \\ hist\_rp ( i - 1 , 1 ) ( P ( j ) )\end{matrix} \qquad ( 2 )$$

where hist_r(i−1,1)(P(j)) represents the frequency (number of times) of the luminance value j on the luminance histogram hist_r(i−1,1), hist_rp(i−1,1)(P(j)) the frequency (number of times) of the luminance value j on the luminance histogram hist_rp(i−1,1), and Σ the summation of the luminance value j=0 to 255.

Then, if the assumption is true, that is, if the difference region s(i,1) of the image f(i) originates from appearance of the body V, then the following expression (3) is satisfied as a relationship in magnitude between the inner product values B1 and B2:
B1≦B2 (3)

This is because, as shown in FIGS. 3A to 3D, while the luminance histogram hist_r(i,1) and the luminance histogram hist_rp(i,1) multiplied to determine the inner product value B1 of the expression (1) do not exhibit coincidence of the distributions of those luminance values which exhibit high frequencies, the luminance histogram hist_r(i−1,1) and the luminance histogram hist_rp(i−1,1) multiplied to determine the inner product value B2 of the expression (2) exhibit coincidence of the distributions of those luminance values which exhibit high frequencies.

On the contrary, if the assumption is false, that is, if the difference region s(i,1) of the image f(i) originates from disappearance of the body V, then the following expression (4) is satisfied as a relationship in magnitude between the inner product values B1 and B2:
B1>B2 (4)

Since the difference region s(i,1) of FIG. 2 satisfies the expression (3), it is determined or detected that the difference region s(i,1) in the image f(i) is a body region Vs(i).

Similarly, if the determination depending upon the luminance histograms described above is performed with regard to the difference region s(i,2) of FIG. 2, then since the difference region s(i,2) satisfies the expression (4), it is determined that the difference region s(i,2) in the image f(i) is the background region BK.

The difference image fd(i,i−1) can be produced from the two images f(i) and f(i−1) to detect the body Vs(i) appearing in the image f(i) in such a manner as described above. Here, also the body Vs(i) disappearing in the image f(i) can be detected similarly as in the detection of the body region Vs(i) appearing in the image f(i). In other words, the body Vs(i) appearing in the image f(i) and the body Vs(i) disappearing in the image f(i) can be detected distinctly from each other.

It is to be noted that, as a method of determining the similarity using luminance histograms of image regions, for example, another method of determining a sum of absolute difference of the factors of the histograms can be adopted. When the assumption is true, that is, when a difference region s(i,1) of the image f(i) originates from appearance of the body V, the sum of absolute difference of the frequencies of the individual luminance values of the luminance histogram hist_r(i,1) and the luminance histogram hist_rp(i,1) is greater than the sum of absolute difference of the frequencies of the individual luminance values of the luminance histogram hist_r(i−1,1) and the luminance histogram hist_rp(i−1,1). This is because, since the luminance histogram hist_r(i−1,1) and the luminance histogram hist_rp(i−1,1) exhibit high frequencies at substantially same luminance values, the frequencies of the luminance values of the luminance histogram hist_r(i−1,1) and the luminance histogram hist_rp(i−1,1) cancel each other, and the absolute difference of the frequencies has a low value. On the other hand, since the luminance histogram hist_r(i,1) and the luminance histogram hist_rp(i,1) exhibit high frequencies at different luminance values from each other, the frequencies of the luminance values of the luminance histogram hist_r(i,1) and the luminance histogram hist_rp(i,1) do not cancel each other, and the absolute difference of the frequencies has a high value.

Furthermore, for example, the luminance values at which the frequency exhibits a maximum value may be compared with each other to determine the similarity between image regions. In other words, in the present embodiment, the example described above of the determination method of the similarities of the four regions of the image region r(i−1,1), peripheral region rp(i−1,1), image region r(i,1) and peripheral region rp(i,1) is a mere example, and also the other methods can be adopted.

While the processes described above are directed to detection of the body V moving in a picked-up image, also in a case wherein the body V which does not exist in a picked-up image at certain time i appears in another picked-up image at next time i+1 or in another case wherein the body V which exists in a picked-up image at certain time i disappears in another picked-up image at next time i+1 as a result of movement of the body V to the outside of the picked-up image, similar processes can be applied to detect the body V although it is different only in that only one difference region appears with respect to the single body V. Moreover, if the plural bodies Vs exist in a picked-up image, similar processes can be applied to detect the bodies Vs.

FIG. 4 shows an example of a configuration of an image processing apparatus which performs the body detection process described hereinabove.

Referring to FIG. 4, the image processing apparatus shown includes an image storage section 11, a reference image storage section 12, a difference region detection section 13, a histogram production section 14 and a determination section 15. The difference region detection section 13 includes a difference calculation section 21 and a labeling section 22.

For example, at certain time i, an image f(i) is supplied to the image storage section 11 from a predetermined image pickup apparatus such as an ITV camera.

Further, an image f(i−1) supplied from the image pickup apparatus to the image storage section 11 at time i−1 prior by a predetermined unit time period (for example, one frame time period) to time i is stored in the reference image storage section 12.

The image storage section 11 stores the image f(i) supplied from the image pickup apparatus into the inside thereof and supplies the image f(i) to the reference image storage section 12 and the difference calculation section 21 of the difference region detection section 13. Further, the image storage section 11 supplies the image f(i) to the histogram production section 14 in response to a request from the histogram production section 14.

The reference image storage section 12 stores the image f(i) supplied thereto from the image storage section 11. Further, the reference image storage section 12 supplies the image f(i−1) at time i−1 prior by a unit time period to the image f(i) at time i, which has been stored in the reference image storage section 12 till then, to the difference calculation section 21 of the difference region detection section 13 at a timing same as the timing at which the image f(i) is supplied thereto from the image storage section 11.

Further, the reference image storage section 12 supplies the image f(i−1) to the histogram production section 14 in response to a request from the histogram production section 14.

The difference calculation section 21 of the difference region detection section 13 performs a difference detection process. In particular, the difference calculation section 21 produces, from the image f(i) supplied thereto from the image storage section 11 and the image f(i−1) supplied thereto from the reference image storage section 12, a difference image fd(i,i−1) of differences (interframe differences) of the luminance values (luminance information) of the pixels corresponding to each other as described hereinabove with reference to FIG. 2. Here, the image f(i) supplied from the image storage section 11 and the image f(i−1) supplied from the reference image storage section 12 are images obtained by picking up the same place (scene).

For example, the difference calculation section 21 selects a certain pixel in the image f(i) as a noticed pixel and calculates the absolute value of the difference between the luminance values (pixel values) of the noticed pixel of the image f(i) and the pixel of the image f(i−1) corresponding to the noticed pixel. Then, the difference calculation section 21 outputs zero with regard to the noticed pixel if the absolute value is lower than a threshold value K1 (K1 is an integer greater than 0) set in advance. On the other hand, if the absolute value is equal to or greater than the threshold value K1 set in advance, then the difference calculation section 21 outputs a predetermined value (for example, 1) with regard to the noticed pixel. Then, the difference calculation section 21 successively selects all of the pixels of the image f(i) as the noticed pixel and performs the processing described above to produce a difference image fd(i,i−1).

It is to be noted that, when the absolute value of the difference between the luminance values (pixel values) of pixels is equal to or higher than the threshold value K1 set in advance, alternatively the difference calculation section 21 may output the luminance value of the noticed pixel of the image f(i) as it is in place of outputting the predetermined value with regard to the noticed pixel.

The difference calculation section 21 supplies the produced difference image fd(i,i−1) to the labeling section 22.

The labeling section 22 performs labeling for the difference image fd(i,i−1). In particular, the labeling section 22 interconnects adjacent ones of those of the pixels of the difference image fd(i,i−1) which have luminance values other than zero to detect a difference region.

Then, if a plurality of difference regions are detected from within the difference image fd(i,i−1), then the labeling section 22 labels each of the difference regions. Here, it is assumed that n difference regions are detected by the labeling section 22. In particular, difference regions s(i,q) (q=1, 2, . . . , n) are detected from the difference image fd(i,i−1).

Here, such a situation sometimes occurs that it is determined that the image f(i) and the image f(i−1) have a difference therebetween due to noise included in the picked-up images picked up by the image pickup apparatus and a difference region s(i,q) is detected. In this instance, if another threshold value K2 (K2 is an integer greater than 0) is set (stored) in advance in the labeling section 22, then the labeling section 22 can delete the difference region s(i,q) from among the labeled difference regions s(i,q) (that is, the labeling section 22 can be determined such that the difference region s(i,q) is not included in the difference regions s(i,q)). This is because it is considered that the difference region s(i,q) originating from an influence of noise which does not belong to the original difference regions s(i,q) is very small. Accordingly, where such a process as described above is performed, a region determined as one of the difference regions s(i,q) in error due to an influence of noise included in an image picked up by the image pickup apparatus can be excepted.

The labeling section 22 of the difference region detection section 13 supplies the difference regions s(i,q) detected in such a manner as described above to the histogram production section 14.

The histogram production section 14 extracts (receives) the image f(i) and the image f(i−1) from the image storage section 11 and the reference image storage section 12, respectively.

Then, the histogram production section 14 sets, with regard to each of the difference regions s(i,q) supplied thereto from the labeling section 22, a region of the image f(i) corresponding to the position of the difference region s(i,q) as an image region r(i,1) and sets a region around the image region r(i,1) as a peripheral region rp(i,1) as described hereinabove with reference to FIG. 2. Further, the histogram production section 14 similarly sets, with regard to the image f(i−1), a region of the image f(i−1) corresponding to the position of the difference region s(i,q) as an image region r(i−1,1) and sets region around the image region r(i−1,1) as a peripheral region rp(i−1,1).

Here, the peripheral region rp(i,1) or rp(i−1,1) is defined, for example, as a region surrounded by a contour of a region formed by expanding a rectangular region circumscribing the image region r(i,1) or the image region r(i−1,1) by C1 (C1 is an integer greater than 0) pixels set in advance in upward, downward, leftward and rightward directions and a contour of the image region r(i,1) or the image region r(i−1,1). Alternatively, the peripheral region rp(i,1) or rp(i−1,1) is defined, for example, as a region surrounded by a contour of a region formed by expanding the image region r(i,1) or the image region r(i−1,1) by C1 pixels set in advance such that a margin may be added to the image region r(i,1) or the image region (i−1,1) and a contour of the image region r(i,1) or the image region r(i−1,1). In other words, the peripheral region rp(i,1) or rp(i−1,1) may be any region only if it has a predetermined area around (on the outer side of) the image region r(i,1) or image region r(i−1,1).

Further, the histogram production section 14 produces, with regard to the four regions of the image region r(i,1), peripheral region rp(i,1), image region r(i−1,1) and peripheral region rp(i−1,1), such four luminance histograms hist_r(i,1), hist_rp(i,1), hist_r(i−1,1) and hist_rp(i−1,1) as described hereinabove with reference to FIGS. 3A to 3D, respectively.

Then, the histogram production section 14 supplies the thus produced four luminance histograms hist_r(i,1), hist_rp(i,1), hist_r(i−1,1) and hist_rp(i−1,1) to the determination section 15 together with the image f(i) supplied thereto from the image storage section 11.

The determination section 15 calculates, based on the four luminance histograms hist_r(i,1), hist_rp(i,1), hist_r(i−1,1) and hist_rp(i−1,1) supplied thereto from the histogram production section 14, the inner product value B1 of the luminance histograms hist_r(i,1) and hist_rp(i,1) and the inner product value B2 of the luminance histograms hist_r(i−1,1) and hist_rp(i−1,1) represented by the expressions (1) and (2) given hereinabove, respectively.

Further, the determination section 15 determines whether the expression (3) or the expression (4) is satisfied as a relationship in magnitude between the inner product values B1 and B2 to determine (detect) whether or not the difference region s(i,q) in the image f(i) is a body region Vs(i).

In particular, if the expression (3) is satisfied as a relationship in magnitude between the inner product values B1 and B2, then the determination section 15 determines (detects) that the difference region s(i,1) in the image f(i) is a body region Vs(i). On the other hand, if the expression (4) is satisfied as a relationship in magnitude between the inner product values B1 and B2, then the determination section 15 determines that the difference region s(i,2) in the image f(i) is the background region BK.

Furthermore, when the expression (3) is satisfied as a relationship in magnitude between the inner product values B1 and B2, that is, when it is determined (detected) that the difference region s(i,1) in the image f(i) is a body region Vs(i), the determination section 15 outputs the image f(i) from the histogram production section 14, from within which the body region Vs(i) is detected, to a succeeding apparatus (not shown).

The apparatus to which the image f(i) is supplied can, for example, output an alarm or store the image f(i), from within which the body V is detected, into a predetermined memory so that the image f(i) may be utilized for a later analysis process.

Now, a body detection process of the image processing apparatus of FIG. 4 is described with reference to a flow chart of FIG. 5.

In the body detection process, since it is necessary to retain an image prior by a unit period of time from the image storage section 11 in the reference image storage section 12, when the image processing apparatus of FIG. 4 performs the body detection process, for example, in a unit of one frame, a frame image (image f(i−1)) inputted to the image processing apparatus of FIG. 4 first is supplied as it is from the image storage section 11 to and stored into the reference image storage section 12. Then, when a next frame image (image f(i)) is supplied to the image storage section 11, the body detection process of FIG. 5 is started.

First at step S1, the difference calculation section 21 produces, from the image f(i) supplied thereto from the image storage section 11 and the image f(i−1) supplied thereto from the reference image storage section 12, a difference image fd(i,i−1) of differences (interframe differences) of the luminance values of the pixels corresponding to each other. Then, the difference calculation section 21 supplies the thus produced difference image fd(i,i−1) to the labeling section 22, whereafter the processing advances to step S2.

At step S2, the labeling section 22 performs labeling for the difference image fd(i,i−1) from the difference calculation section 21, and then the processing advances to step S3. In particular, the labeling section 22 interconnects adjacent ones of those of the pixels of the difference image fd(i,i−1) which have luminance values other than zero to detect n difference regions s(i,q) (q=1, 2, . . . , n).

Here, in order to prevent a region from being determined as one of the difference regions s(i,q) in error due to an influence of noise included in any image picked up by the image pickup apparatus as described hereinabove, the labeling section 22 determines whether or not the area Si,q of the difference region s(i,q) is smaller than the threshold value K2. If the area Si,q of any of the labeled difference regions s(i,q) is smaller than the threshold value K2, then the labeling section 22 deletes the difference region s(i,q) from among the labeled difference regions s(i,q).

At step S3, the labeling section 22 determines whether or not there remains a difference region s(i,q) which has not been made an object of processing at steps S4 to S6 described below. If it is determined at step S3 that there remains no such difference region s(i,q), then the processing skips steps S4 to S7 and advances directly to step S8.

On the other hand, if it is determined at step S3 that there remains a difference region s(i,q), then the processing advances to step S4, at which the labeling section 22 supplies one of those difference regions s(i,q) which have not been made an object of the processing to the histogram production section 14. Then at step S4, the histogram production section 14 sets, to each of the images f(i) and f(i−1), the four regions of the image region r(i,1), peripheral region rp(i,1), image region r(i−1,1) and peripheral region rp(i−1,1) described hereinabove with reference to FIG. 2 determined from the difference region s(i,q) supplied from the labeling section 22 and produces four luminance histograms hist_r(i,1), hist_rp(i,1), hist_r(i−1,1), and hist_rp(i−1,1) corresponding to the four regions, respectively. Then, the histogram production section 14 supplies the produced four luminance histograms hist_r(i,1), hist_rp(i,1), hist_r(i−1,1), and hist_rp(i−1,1) to the determination section 15 together with the image f(i) stored in the image storage section 11. Thereafter, the processing advances from step S4 to step S5.

At step S5, the determination section 15 performs calculation of the similarity among the four luminance histograms hist_r(i,1), hist_rp(i,1), hist_r(i−1,1), and hist_rp(i−1,1) supplied thereto from the histogram production section 14. In particular, the determination section 15 calculates the inner product value B1 of the luminance histogram hist_r(i,1) and the luminance histogram hist_rp(i,1) and the inner product value B2 of the luminance histogram hist_r(i−1,1) and the luminance histogram hist_rp(i−1,1) represented by the expressions (1) and (2) given hereinabove, respectively.

Then, the processing advances from step S5 to step S6, at which the determination section 15 determines a relationship in magnitude between the inner product values B1 and B2 by comparison between them. If it is determined at step S6 that the inner product value B1 is higher than the inner product value B2, then it is determined that the difference region s(i,q) is the background region BK. Then, the processing returns to step S3 so that the processes at the steps beginning with step S3 are repeated.

On the other hand, if it is determined at step S6 that the inner product value B1 is not higher than the inner product value B2, that is, the inner product value B1 is equal to or lower than the inner product value B2, then it is determined (detected) that the difference region s(i,1) is a body region Vs(i). Then, the processing advances to step S7, at which the determination section 15 outputs the image f(i), from within which the body region Vs(i) is detected, to the next apparatus, whereafter the processing advances to step S8.

At step S8, it is determined whether or not inputting of an image is ended, that is, whether or not an image is inputted newly to the image storage section 11. If it is determined at step S8 that inputting of an image is not ended, that is, a new image is inputted to the image storage section 11, then the processing advances to step S9, at which the image storage section 11 supplies the image f(i) currently stored in the inside thereof to the reference image storage section 12 and further stores the new image therein. The reference image storage section 12 stores (updates) the image supplied thereto from the image storage section 11 in an overwriting fashion. Thereafter, the processing returns from step S9 to step S1 so that the processes at the steps beginning with step S1 are repeated.

On the other hand, if it is determined at step S8 that inputting of an image is ended, that is, no new image is inputted to the image storage section 11, then the processing is ended.

As described above, with the body detection process, since a body appearing in a picked-up image can be detected (extracted) using two images, the process can be performed at a high speed using a memory of a reduced capacity.

In the body detection process of FIG. 5, when it is first determined (detected) at step S6 that the difference region s(i,1) is a body region Vs(i), even if there remains another difference region s(i,1) with regard to which determination (calculation) of the similarity is not performed as yet, the image f(i) is outputted to the succeeding apparatus without performing the determination of the similarity with regard to the difference region s(i,1). However, the body detection process may be modified such that, when there remains a difference region s(i,1) which is determined (detected) as a body region Vs(i) after the determination of the similarly is performed with regard to all of the difference regions s(i,1), the determination section 15 outputs the image f(i) to the succeeding apparatus.

In the example described above, it is determined whether or not the area Si,q of a difference region s(i,q) is smaller than the threshold value K2 in order to except a region determined as one of the difference regions s(i,q) in error due to an influence of noise included in an image picked up by the image pickup apparatus. However, as a method of reducing the influence of noise when two images f(i) and f(i−1) are compared with each other, also a method wherein, for example, a single image is divided into a plurality of blocks including CX pixels in a row and CY pixels in a column and a difference image fd(i,i−1) is produced by arithmetic operation in a unit of a block obtained by the division is available. Here, CX and CY are integers greater than 0.

For arithmetic operation in a unit of a block, a method wherein, for example, a normalized correlation between each corresponding blocks of the images f(i) and f(i−1) is arithmetically operated and a difference is calculated in a unit of a block is available. Meanwhile, as different arithmetic operation in a unit of a block, for example, it is possible to compare luminance values (pixel values) of corresponding pixels of two images f(i) and f(i−1) in a unit of a block, count the number of those pixels with regard to which the absolute value of the difference in luminance value is equal to or higher than the threshold value K1 and determine, if the counted pixel number is greater than a threshold value K3 (K3 is an integer greater than 0), that the blocks have a difference from each other (detect a difference).

Then, an image obtained as a result of the detection of the difference described above with regard to all blocks is determined as a difference image fd(i,i−1), and the processes at steps S2 to S9 of the body detection process of FIG. 5 described hereinabove can be performed for the difference image fd(i,i−1).

Further, as another method of reducing the influence of noise, when comparison between corresponding pixels of the images f(i) and f(i−1) is performed, where a pixel of an object of the comparison is determined as a noticed pixel, an average value of pixels including surrounding pixels of the noticed pixel (for example, several pixels on the upper, lower, left and right sides of the noticed pixel) may be determined as the pixel value of the noticed pixel. In particular, surrounding pixels including a noticed pixel can be regarded as a reference region to be used as a reference when comparison between corresponding pixels (noticed pixels) of the images f(i) and f(i−1) is to be performed, and the difference image fd(i,i−1) may be produced by arithmetic operation (comparison) of the pixels values in the reference regions.

Further, in the example described above, the inner product value B1 as the similarity between the image region r(i,1) and the peripheral region rp(i,1) around the same is determined using the image region r(i,1) and the peripheral region rp(i,1), and the inner product value B2 as the similarity between the image region r(i−1,1) and the peripheral region rp(i−1,1) around the same is determined using the image region r(i−1,1) and the peripheral region rp(i−1,1). However, since both of the peripheral region rp(i,1) and the peripheral region rp(i−1,1) are the background region BK, the peripheral region rp(i,1) and the peripheral region rp(i−1,1) may be exchanged to calculate the inner product value B1 or B2 as the similarity.

In particular, for example, the following expression (5) may be adopted in place of the expression (2) for determining the inner product value B2 given hereinabove:
B2=hist_{—}r(i−1,1)·hist_{—}rp(i,1) (5)

Further, for example, the following expression (6) may be adopted in place of the expression (1) for determining the inner product value B1 given hereinabove:
B1=hist_{—}r(i,1)·hist_{—}rp(i−1,1) (6)

Furthermore, in calculation of the inner product values B1 and B2 as the similarities, also it is possible to use a luminance histogram of a synthesized image wherein an image of the peripheral region rp(i,1) and an image of the peripheral region rp(i−1,1) are synthesized.

In particular, for example, where a luminance histogram of a synthesized image wherein an image of the peripheral region rp(i,1) and an image of the peripheral region rp(i−1,1) are synthesized is represented by Hist_rp(x,1), the following expression (7) can be adopted in place of the expression (1) for determining the inner product value B1 given hereinabove:
B1=hist_{—}r(i,1)·Hist_{—}rp(x,1) (7)

Further, the following expression (8) can be adopted in place of the expression (2) for determining the inner product value B2 given hereinabove:
B2=hist_{—}r(i−1,1)·Hist_{—}rp(x,1) (8)

Whichever one of the expressions (5) to (8) given above is adopted, the expressions (3) and (4) are satisfied.

FIG. 6 shows another example of a configuration of an image processing apparatus which performs the body detection process to which the present invention is applied. Referring to FIG. 6, the image processing apparatus shown includes an image storage section 11, a reference image storage section 12, a difference region detection section 13, a histogram production section 14 and a determination section 15 all similar to those of the image processing apparatus of FIG. 4. The image processing apparatus of FIG. 6 additionally includes an image correction section 31.

An image inputted from the image pickup apparatus sometimes suffers from blurring of an image, for example, caused by a shake of the camera or from a variation in brightness caused by a variation in weather or the like. Such blurring or a variation in brightness sometimes deteriorates the accuracy in the difference detection process of the difference calculation section 21 of the difference region detection section 13. Therefore, in the embodiment of FIG. 6, in order to allow the difference detection process to be performed stably, an image correction process is performed as a pre-process to the difference detection process, and to this end, the image correction section 31 is provided.

To the image correction section 31 of FIG. 6, an image f(i) and another image f(i−1) are supplied from the image storage section 11 and the reference image storage section 12, respectively. The image correction section 31 performs a predetermined image correction process and supplies the image f(i) and the image f(i−1) after the correction process to the difference calculation section 21 of the difference region detection section 13.

The image correction section 31 can perform a blurring correction process as the image correction process, for example, corresponding to a shake of the camera. As the blurring correction process, a blurring correction technique disclosed, for example, in Japanese Patent Laid-open No. Hei 6-169424 can be adopted. Detailed description of the blurring correction process is omitted herein because it is disclosed in the document mentioned above.

Further, the image correction section 31 can perform, for example, a luminance correction process against a variation in brightness of the entire image caused by a variation of the weather. The luminance correction process is a process of adjusting the luminance values of two images to each other and uses normalization of the images. In particular, in this instance, a maximum value and a minimum value of the luminance value of an image is detected, and the image is normalized so that the minimum value and the maximum value may range from 0 to 255. Accordingly, if the luminance correction process (image normalization process) is performed for two images for which the difference detection process is to be performed, then since the luminance values of the two images are corrected so that the minimum values and the maximum values become 0 and 255, respectively, difference information between the two images can be detected stably irrespective of any variation in brightness of the two images.

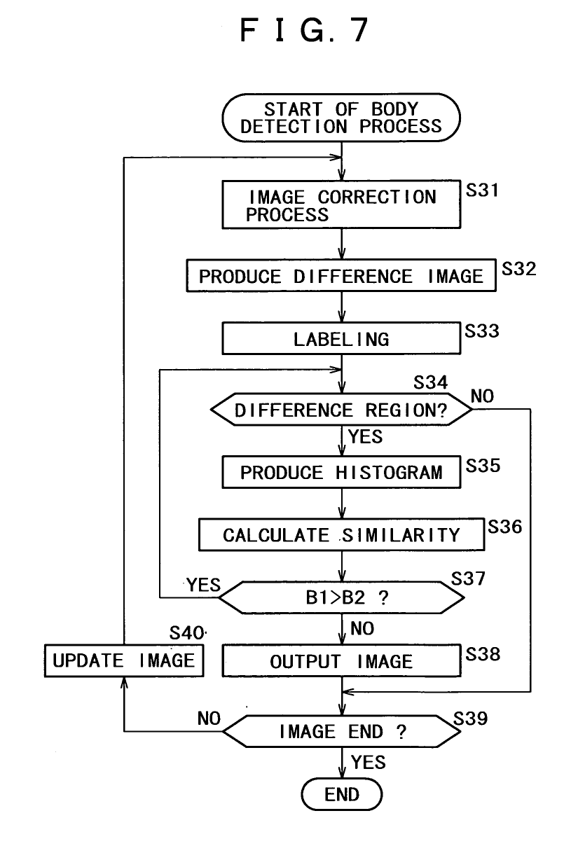

Now, the body detection process of the image processing apparatus of FIG. 6 is described with reference to a flow chart of FIG. 7.

At steps S32 to S40 of FIG. 7, processes similar to those at steps S1 to S9 of FIG. 5 are performed, respectively. In other words, the body detection process of FIG. 7 includes a process at step S31 added prior to the step S32 corresponding to the step S1 of FIG. 5.

First at step S31, the image correction section 31 performs image correction processes such as a blurring correction process and a luminance correction process for each of the image f(i) supplied from the image storage section 11 and the image f(i−1) supplied from the reference image storage section 12 and supplies the images f(i) and f(i−1) after the image correction processes to the difference calculation section 21 of the difference region detection section 13. Thereafter, the processing advances to step S32.

At step S32, the difference calculation section 21 produces a difference image fd(i,i−1) of differences (interframe differences) between the luminance values of corresponding pixels of the image f(i) and the image f(i−1) after the image correction processes supplied from the image correction section 31. Then, the difference calculation section 21 supplies the produced difference image fd(i,i−1) to the labeling section 22. Thereafter, the processing advances to step S33.

At steps S33 to S40, four luminance histograms hist_r(i,1), hist_rp(i,1), hist_r(i−1,1), and hist_rp(i−1,1) corresponding to the four regions of the image region r(i,1), peripheral region rp(i,1), image region r(i−1,1) and peripheral region rp(i−1,1) of the images f(i) and f(i−1) determined from the difference region s(i,q) are used to calculate (compare) the similarities to determine whether or not the difference region s(i,q) is a body region Vs(i) similarly as in the processes at steps S2 to S9 of FIG. 5. Then, if it is determined that the difference region s(i,q) is a body region Vs(i), then the image f(i) is outputted to the succeeding apparatus.

As described above, since, also with the body detection process of FIG. 7, two images can be used to detect (extract) a body appearing in a picked-up image, the body detection process can be performed at a high speed with a memory of a reduced capacity.

Further, in the process of FIG. 7, since the predetermined image correction processes are performed before the difference detection process is performed, difference information between two images can be detected stably by the body detection process.

Further, in the embodiments described above, the image pickup apparatus for supplying an image to the image processing apparatus of FIG. 4 or 6 is a monochromatic ITV camera and a luminance value of 8 bits is outputted as a pixel value of each pixel. However, the image processing apparatus of FIG. 4 or 6 can be applied also where an image to be supplied thereto is a color image.

The image processing apparatus which performs the body detection process described above can be applied not only to a security system which uses a monitoring camera but also, for example, to an automatic door apparatus which detects a person and opens or closes a door, an illumination apparatus which supplies illumination light to a body following the movement of the body, and so forth.

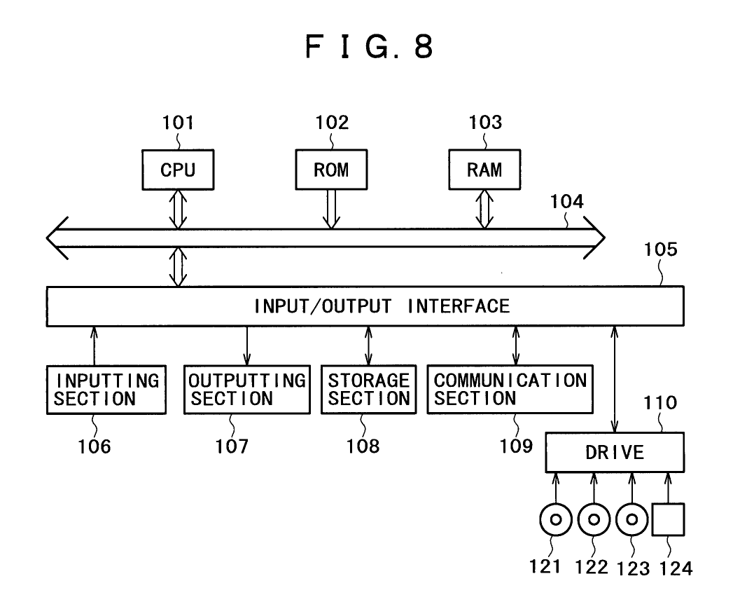

While the series of processes described above can be executed by hardware, it may otherwise be executed by software. Where the series of processes described above are executed by software, for example, the image processing apparatus can be implemented by causing the program to be executed by such a computer as shown in FIG. 8.

Referring to FIG. 8, a central processing unit (CPU) 101 executes various processes in accordance with a program stored in a ROM (Read Only Memory) 102 or a program loaded from a storage section 108 into a RAM (Random Access Memory) 103. Also data necessary for the CPU 101 to execute the processes are suitably stored into the RAM 103.

The CPU 101, ROM 102 and RAM 103 are connected to one another by a bus 104. Also an input/output interface 105 is connected to the bus 104.

An inputting section 106 including a keyboard, a mouse and so forth, an outputting section 107 including a display unit which may be a CRT (Cathode Ray Tube) or an LCD (Liquid Crystal Display) unit, a speaker and so forth, a storage section 108 formed from a hard disk or the like, a communication section 109 including a modem, a terminal adapter and so forth are connected to the input/output interface 105. The communication section 109 performs a communication process through a network such as the Internet.

Further, as occasion demands, a drive 110 is connected to the input/output interface 105. A magnetic disk 121, an optical disk 122, a magneto-optical disk 123, a semiconductor memory 124 or the like is suitably loaded into the drive 110, and a computer program read from the loaded medium is installed into the storage section 108 as occasion demands.

It is to be noted that, in the present specification, the steps which describe the program recorded in a recording medium may be but need not necessarily be processed in a time series in the order as described, and include processes which are executed in parallel or individually without being processed in a time series.

While preferred embodiments of the present invention have been described using specific terms, such description is for illustrative purposes only, and it is to be understood that changes and variations may be made without departing from the spirit or scope of the following claims.

1. An image processing apparatus comprising:
difference region detection means for detecting a difference region in which a first image and a second image supplied from image pickup means for picking up an image have a difference; and
determination means for determining the similarity between an image of the difference region and an image in a peripheral region around the difference region and determining based on the similarity whether the difference region is a region in which a body appears or a region in which a body disappears.

2. An image processing apparatus according to claim 1, wherein said difference region detection means includes comparison means for comparing pixel values of corresponding pixels of the first and second images with each other, and detects the difference region based on a result of the comparison by said comparison means.

3. An image processing apparatus according to claim 1, wherein said difference region detection means includes comparison means for dividing each of the first and second images into a plurality blocks and comparing the first and second images with each other in a unit of a block, and detects the difference region based on a result of the comparison by said comparison means.

4. An image processing apparatus according to claim 2, wherein said difference region detection means includes comparison means for performing the comparison between the corresponding pixels of the first and second images with each other using pixel values of those pixels in a region around each pixel of an object of comparison, and detects the difference region based on a result of the comparison by said comparison means.

5. An image processing apparatus according to claim 1, wherein said determination means determines a first similarity which represents a similarity between the image of the first image in the difference region and an image of the first image in a peripheral region around the difference region and a second similarity which represents a similarity between an image of the second image in the difference region and an image of the second image in a peripheral region around the difference region, and determines based on a relationship in magnitude between the first and second similarities whether the difference region is a region in which a body appears or a region in which a body disappears.

6. An image processing apparatus according to claim 1, wherein said determination means determines a first similarity which represents a similarity between the image of the first image in the difference region and an image of the first image in a peripheral region around the difference region and a second similarity which represents a similarity between an image of the second image in the difference region and the image of the first image in the peripheral region around the difference region, and determines based on a relationship in magnitude between the first and second similarities whether the difference region is a region in which a body appears or a region in which a body disappears.

7. An image processing apparatus according to claim 1, wherein said determination means determines a first similarity which represents a similarity between the image of the first image in the difference region and an image of the second image in a peripheral region around the difference region and a second similarity which represents a similarity between the image of the second image in the difference region and the image of the second image in the peripheral region around the difference region, and determines based on a relationship in magnitude between the first and second similarities whether the difference region is a region in which a body appears or a region in which a body disappears.

8. An image processing apparatus according to claim 1, wherein said determination means determines a first similarity which represents a similarity between the image of the first image in the difference region and a synthesized image of an image of the first image in a peripheral region around the difference region and an image of the second image in a peripheral region around the difference region and a second similarity which represents a similarity between the image of the second image in the difference region and the synthesized image, and determines based on a relationship in magnitude between the first and second similarities whether the difference region is a region in which a body appears or a region in which a body disappears.

9. An image processing apparatus according to claim 1, further comprising correction means for performing a predetermined correction process for the first and second images, and wherein said difference region detection means detects a difference region in which the first and second images after the predetermined correction process have a difference.

10. An image processing method comprising:
a difference region detection step of detecting a difference region in which a first image and a second image supplied from image pickup means for picking up an image have a difference; and
a determination step of determining the similarity between an image of the difference region and an image in a peripheral region around the difference region and determining based on the similarity whether the difference region is a region in which a body appears or a region in which a body disappears.

11. A program for causing a computer to execute a process comprising:
a difference region detection step of detecting a difference region in which a first image and a second image supplied from image pickup means for picking up an image have a difference; and
a determination step of determining the similarity between an image of the difference region and an image in a peripheral region around the difference region and determining based on the similarity whether the difference region is a region in which a body appears or a region in which a body disappears.
